(19) United States
(12) Patent Application Publication
(10) Pub. No.: US 2026/0239090 A1
(43) Pub. Date: Aug. 13, 2026

(54) WIRELESS DEVICE, SIGNAL TRANSMISSION SYSTEM AND SIGNAL PROCESSING METHOD

(71) Applicant: NTT, Inc., Tokyo (JP)

(72) Inventors: Kenji MIYAMOTO, Musashino-shi (JP); Yoshihito SAKAI, Musashino-shi (JP); Tatsuya SHIMADA, Musashino-shi (JP)

(73) Assignee: NTT, Inc., Tokyo (JP)

(21) Appl. No.: 19/153,928

(22) PCT Filed: Feb. 8, 2023
(86) PCT No.: PCT/JP2023/004176

§ 371 Date: Aug. 5, 2025

(51) Int. Cl. H04W 28/02

(52) U.S. Cl. CPC H04W 28/0236

(57) ABSTRACT

A wireless terminal includes an application function unit that processes a signal transmitted from a host device to a wireless terminal, and a delay control unit that acquires network transfer information, which is information regarding a traffic flow, from the outside for each traffic flow from the host device toward the wireless terminal, and executes adjustment processing of adjusting a frame interval of a plurality of frames based on the acquired network transfer information before the plurality of frames are input to the application function unit.

### TECHNICAL FIELD

The present invention relates to a wireless terminal, a signal transfer system, and a signal processing method.

### BACKGROUND ART

In signal transmission in a conventional mobile communication system, in a case where a base station and a wireless terminal exchange signal, time division duplex (TDD) in which a downlink signal and an uplink signal are alternately transmitted in a time domain is used, and at that time, transmission and reception of signals are performed in units of radio transmission frames called a transport block.

### CITATION LIST

### Non Patent Literature

Non Patent Literature 1:“3GPP TS 38.300V 16.7.0 ”, 3GPP (registered trademark), 2022.

Non Patent Literature 2:“3GPP TS 38.214V 16.7.0 ”, 3GPP (registered trademark), 2022.

### SUMMARY OF INVENTION

### Technical Problem

However, jitter may occur due to a downlink transmission waiting time during uplink transmission in TDD or a waiting time for forming a transport block in a case where a size of the transport block is larger than a frame size received from an upper network. This may occur even if transmission to the base station is performed in a state in which frame transmission intervals are aligned in the upper network and jitter is small in each downlink traffic flow.

As a result, end-to-end jitter may increase due to jitter in a radio transmission section. Note that such a problem is common not only in mobile communication systems but also in wireless communication systems other than mobile communication systems.

In view of the above circumstances, an object of the present invention is to provide a technology capable of reducing an increase in jitter.

### Solution to Problem

An aspect of the present invention is a wireless terminal including an application function unit that processes a signal transmitted from a host device to a wireless terminal, and a delay control unit that acquires network transfer information, which is information regarding a traffic flow, from the outside for each traffic flow from the host device toward the wireless terminal, and executes adjustment processing of adjusting a frame interval of a plurality of frames based on the acquired network transfer information before the plurality of frames are input to the application function unit.

An aspect of the present invention is a signal transfer system including the wireless terminal described above, one or more base stations that accommodate the wireless terminal, one or more transfer devices that transfer downstream communication addressed to the wireless terminal, a transfer device controller that controls the one or more transfer devices, an information acquisition unit that acquires network transfer information which is information related to a traffic flow for each traffic flow from a host device toward the wireless terminal, an information notification unit that notifies the wireless terminal of the network transfer information acquired by the information acquisition unit, and a delay control unit that executes, in the wireless terminal, adjustment processing of adjusting a frame interval of a plurality of frames based on the network transfer information notification of which is provided from the information notifying unit before the plurality of frames are input to an application function unit that processes the plurality of frames transmitted from the host device to the wireless terminal.

An aspect of the present invention is a signal processing method including acquiring network transfer information that is information related to a traffic flow from the outside for each traffic flow from a host device toward a wireless terminal, and executing adjustment processing of adjusting a frame interval of a plurality of frames based on the acquired network transfer information before the plurality of frames are input to an application function unit that processes a signal transmitted from the host device to the wireless terminal.

### Advantageous Effects of Invention

According to the present invention, it is possible to reduce an increase in jitter.

### BRIEF DESCRIPTION OF DRAWINGS

FIG. 1 A diagram illustrating a system configuration example of a signal transfer system according to a first embodiment.

FIG. 2 A diagram for illustrating an outline of adjustment processing in the first embodiment.

FIG. 3 A flowchart illustrating an example of a flow of processing executed by the signal transfer system according to the first embodiment.

FIG. 4 A diagram illustrating a system configuration example of a signal transfer system according to a modification example of the first embodiment.

FIG. 5 A diagram illustrating a system configuration example of a signal transfer system according to a second embodiment.

FIG. 6 A flowchart illustrating an example of a flow of processing executed by the signal transfer system according to the second embodiment.

FIG. 7 A diagram illustrating a system configuration example of a signal transfer system according to a third embodiment.

FIG. 8 A flowchart illustrating an example of a flow of processing executed by the signal transfer system according to the third embodiment.

FIG. 9 A diagram illustrating a system configuration example of a signal transfer system according to a fourth embodiment.

FIG. 10 A flowchart illustrating an example of a flow of processing executed by the signal transfer system according to the fourth embodiment.

### DESCRIPTION OF EMBODIMENTS

Hereinafter, an embodiment of the present invention will be described with reference to the drawings.

### First Embodiment

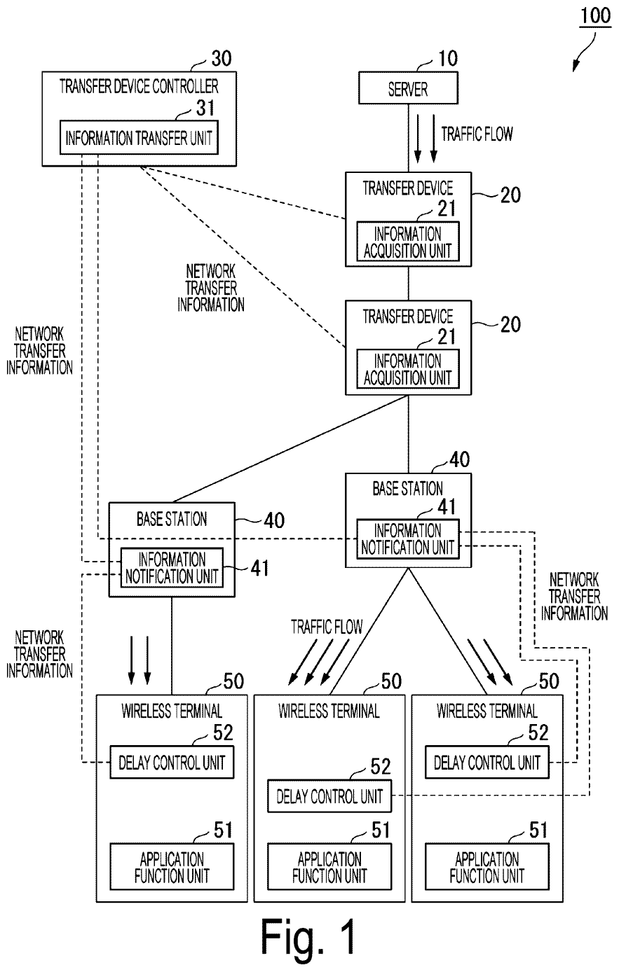

FIG. 1 is a diagram illustrating a system configuration example of a signal transfer system 100 according to a first embodiment. The signal transfer system 100 is a system that transfers a signal from one communication device to another communication device. The signal transfer system 100 includes, for example, a server 10, one or more transfer devices 20, a transfer device controller 30, one or more base stations 40, and one or more wireless terminals 50.

The server 10 is a device that communicates with each of one or more wireless terminals 50. For example, the server 10 transmits a downlink signal addressed to the wireless terminal 50.

The transfer device 20 is a device that transfers a signal exchanged between a host device and each of one or more wireless terminals 50. For example, the transfer device 20 transfers the downlink signal transmitted from the server 10 to the base station 40 to which the wireless terminal 50 as a destination is connected. Further, the transfer device 20 acquires network transfer information for each traffic flow from the server 10 toward the wireless terminal 50.

The network transfer information is information regarding a traffic flow. The information regarding the traffic flow indicates, for example, a frame size and a transmission interval. Therefore, the network transfer information includes, for example, information indicating a frame size and a transmission interval. The frame size and the transmission interval indicated by the information indicating a frame size and a transmission interval are, for example, a downlink frame size and a transmission interval.

The transfer device controller 30 is a device that controls one or more transfer devices 20 by transmitting a control signal. Further, the transfer device controller 30 acquires the network transfer information acquired by the transfer device 20 and transfers the acquired network transfer information to each base station 40.

The base station 40 is a device that communicates with each of one or more wireless terminals 50. For example, the base station 40 transmits a signal transferred from the transfer device 20 to the wireless terminal 50, and transfers a signal received from the wireless terminal 50 to the transfer device 20. Further, the base station 40 notifies the wireless terminal 50 connected to the base station itself of the network transfer information transferred from the transfer device controller 30.

The wireless terminal 50 executes adjustment processing based on the network transfer information notification of which is provided from the base station 40. The adjustment processing is processing of adjusting a frame interval of a plurality of frames based on the network transfer information. The processing of adjusting the frame intervals of the plurality of frames is processing of adjusting the frame intervals of the plurality of frames to be uniform, and the frame intervals may be adjusted by, for example, shaping the plurality of frames or adding a delay to each of the plurality of frames. The wireless terminal 50 executes the above-described adjustment processing before the signal transmitted from the base station 40 is input to the application function in the terminal. As a result, it is possible to perform control such that jitter is minimized in the wireless terminal 50.

Here, the above-described frame means a frame propagated in the downlink direction and transmitted to a transmission destination such as the wireless terminal 50. Therefore, in a case where the transmission destination is the wireless terminal 50, the frame is transmitted from the server 10 to the wireless terminal 50.

The one or more transfer devices 20, the transfer device controller 30, the one or more base stations 40, and the one or more wireless terminals 50 included in the signal transfer system 100 are configured using, for example, a processor such as central processing unit (CPU), a memory, and a communication interface. Each device of the one or more transfer devices 20, the transfer device controller 30, the one or more base stations 40, and the one or more wireless terminals 50 functions as a communication device including a control unit when the processor executes a program.

The control unit provides each function for causing the communication device to function as the transfer device 20, the transfer device controller 30, the base station 40, or the wireless terminal 50. All or some of the functions of the control unit may be implemented by using hardware such as an application specific integrated circuit (ASIC), a programmable logic device (PLD), or a field programmable gate array (FPGA).

The program may be recorded on a computer-readable recording medium. Examples of the computer-readable recording medium include a portable medium such as a flexible disk, a magneto-optical disc, a ROM, a CD-ROM, or a semiconductor storage device (e.g., solid state drive (SSD)), or a storage device such as a hard disk or a semiconductor storage device internally installed in a computer system. The above-described program may be transmitted via a telecommunication line.

Next, a specific configuration of each device will be described. Each transfer device 20 includes an information acquisition unit 21. The information acquisition unit 21 acquires the network transfer information based on the signal received by the transfer device 20.

The transfer device controller 30 includes an information transfer unit 31. The information transfer unit 31 acquires the network transfer information acquired by the information acquisition unit 21 of each transfer device 20. The information transfer unit 31 transfers the acquired network transfer information to a predetermined transfer destination such as the base station 40.

Note that the information transfer unit 31 may execute analysis processing (hereinafter, it is referred to as “analysis processing”) based on the network transfer information acquired from the plurality of information acquisition units 21. The analysis processing includes, for example, processing of averaging values related to states of frames such as frame sizes and frame transmission intervals received from the plurality of information acquisition units 21.

The analysis processing may include, for example, processing of predicting a state of a future frame such as a future frame size or a frame transmission interval based on a value related to a state of a frame such as a frame size or a frame transmission interval received from the plurality of information acquisition units 21. The result of the analysis processing is used for adjustment processing for future communication, for example, and has an effect that jitter can be reduced even for a frame for which the network transfer information has not been transferred to the base station 40.

Each base station 40 includes an information notification unit 41. The information notification unit 41 included in the base station 40 acquires the network transfer information transferred from the information transfer unit 31. The information notification unit 41 included in the base station 40 notifies the wireless terminal 50 of the acquired network transfer information. Note that the information notification unit 41 may provide notification of the network transfer information together with the scheduling notification to the wireless terminal 50.

Note that each of the base stations 40 may be, for example, a Wi-Fi (registered trademark) access point. The signal transfer system 100 is not necessarily applied to a mobile communication system, and may be applied to a wireless communication system other than a mobile communication system.

The wireless terminal 50 includes an application function unit 51 and a delay control unit 52. The application function unit 51 processes a signal transmitted from the server 10 to the wireless terminal 50. The delay control unit 52 acquires the network transfer information from the base station 40, and executes adjustment processing based on the acquired network transfer information before a plurality of frames are input to the application function unit 51. For example, the delay control unit 52 executes adjustment processing so that the frame intervals of the plurality of frames are uniform. The delay control unit 52 may shape the plurality of frames so that the frame intervals of the plurality of frames are uniform, or may add a delay to each of the plurality of frames so that the frame intervals of the plurality of frames are uniform.

In the signal transfer system 100 according to the first embodiment, the information acquisition unit 21 is included in the control unit of the information acquisition unit 21, the information transfer unit 31 is included in the control unit of the transfer device controller 30, the information notification unit 41 is included in the control unit of the base station 40, and the application function unit 51 and the delay control unit 52 are included in the control unit of the wireless terminal 50.

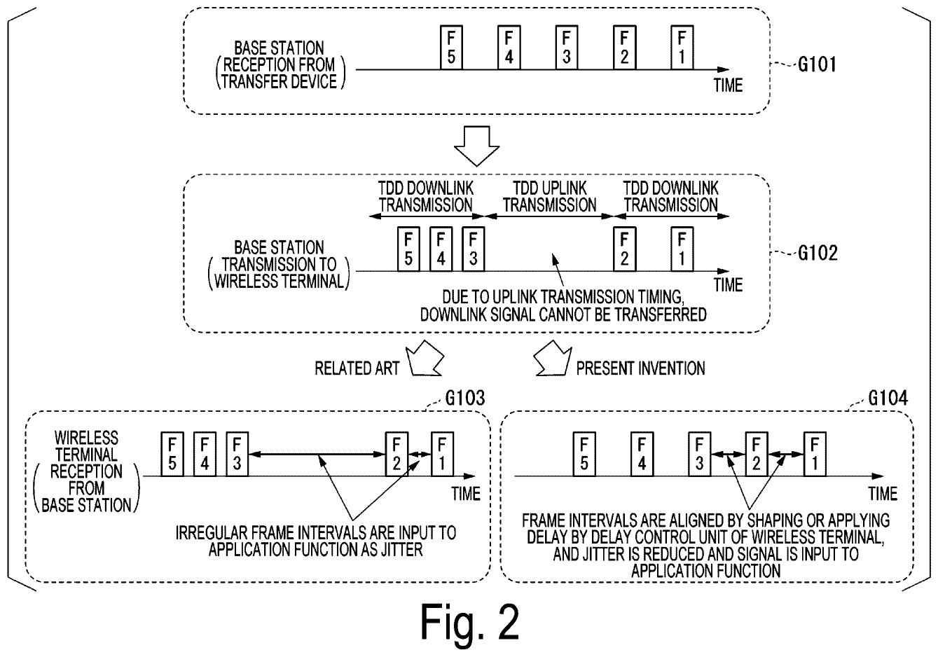

Next, an outline of the above-described adjustment processing will be described. FIG. 2 is a diagram for illustrating an outline of adjustment processing in the first embodiment. An image G101 in FIG. 2 illustrates an example of a signal transferred from the transfer device 20 and received by the base station 40. In the image G101, five frames F1 to F5 are illustrated as signals received by the base station 40. An image G102 of FIG. 2 illustrates an example of a state of a signal transmitted from the base station 40 to the wireless terminal 50. In the image G102, a period between the frame F2 and the frame F3 is an uplink transmission timing in TDD.

A downlink signal cannot be transmitted during the period of the uplink transmission timing. As a result, conventionally, as illustrated in an image G103, when the wireless terminal 50 receives a signal transmitted from the base station 40, the time interval between the frame F1 and the frame F2, the time interval between the frame F2 and the frame F3, and the time interval between the frame F3 and the frame F4 are non-uniform. The non-uniformity of the frame interval increases jitter.

On the other hand, in the adjustment processing in the first embodiment, adjustment is performed so that the frame intervals of the plurality of frames are uniform as described above. As a result, as illustrated in an image G104, the frame intervals of the plurality of frames become uniform. Therefore, in the example of the image G104, jitter is reduced. As described above, by executing the adjustment processing, an increase in jitter is curbed.

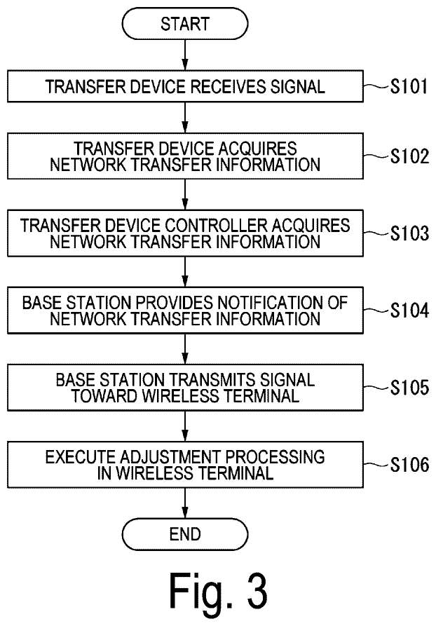

FIG. 3 is a flowchart illustrating an example of a flow of processing executed by the signal transfer system 100 according to the first embodiment. In the signal transfer system 100, the processing illustrated in FIG. 3 is repeatedly performed.

The transfer device 20 receives a signal transmitted from the server 10 (step S101). The information acquisition unit 21 included in the transfer device 20 acquires the network transfer information based on the received signal (step S102). The information acquisition unit 21 transmits the acquired network transfer information to the transfer device controller 30. Further, the information acquisition unit 21 transfers the received signal to the base station 40 to which the wireless terminal 50 as a destination is connected. The processing in step S102 is performed in all the transfer devices 20.

The information transfer unit 31 of the transfer device controller 30 acquires the network transfer information transmitted from each information acquisition unit 21 (step S103). The information transfer unit 31 transfers the acquired network transfer information to each base station 40. Note that the information transfer unit 31 transfers the acquired network transfer information to each base station 40 every time the network transfer information is acquired.

The information notification unit 41 included in the base station 40 acquires the network transfer information transferred from the information transfer unit 31. The information notification unit 41 notifies the wireless terminal 50 of the acquired network transfer information (step S104). Further, the base station 40 transmits the downlink signal transferred from the transfer device 20 to the wireless terminal 50 (step S105).

The delay control unit 52 of the wireless terminal 50 acquires the network transfer information and the downlink signal notification of which is provided from the base station 40. The delay control unit 52 grasps the frame size and the transmission interval of the frame based on the acquired network transfer information. The delay control unit 52 acquires a plurality of frames corresponding to the grasped frame size as downlink signals, and then executes adjustment processing on the plurality of frames (step S106). As a result, the frame intervals of the plurality of frames are uniformly adjusted, and the jitter is reduced. Thereafter, the delay control unit 52 inputs the plurality of frames subjected to the adjustment processing to the application function unit 51. The application function unit 51 processes a plurality of input frames.

According to the signal transfer system 100 configured as described above, before the plurality of frames are input to the application function unit 51, the wireless terminal 50 executes the adjustment processing of adjusting the frame interval of the plurality of frames based on the network transfer information acquired from the base station 40. This makes it possible to reduce jitter occurring in the downlink.

### Modification Example

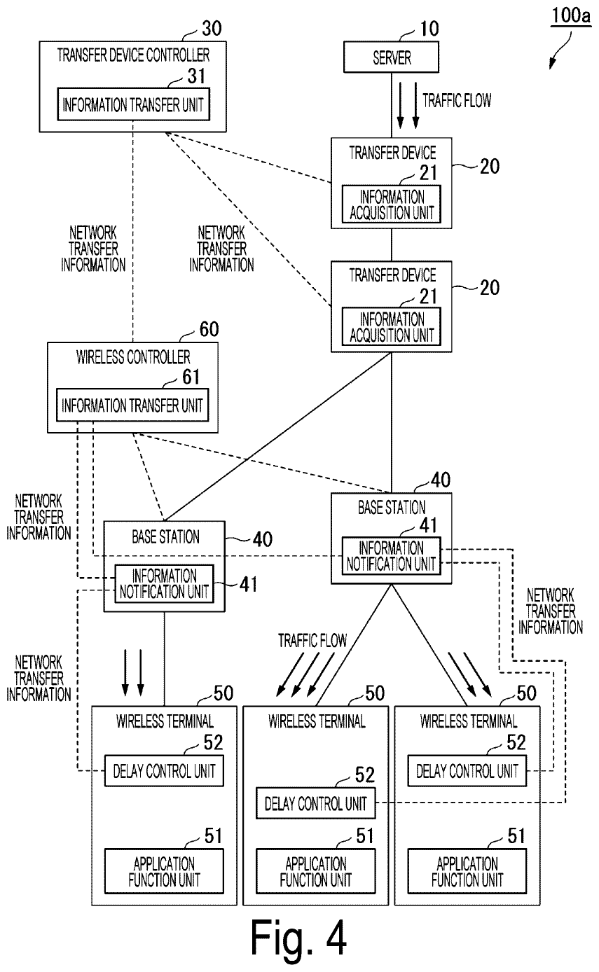

The signal transfer system 100 may include a wireless controller 60, and the base station 40 may obtain the network transfer information from the wireless controller 60. FIG. 4 is a diagram illustrating a system configuration example of a signal transfer system 100a according to a modification example of the first embodiment. The signal transfer system 100a includes, for example, the server 10, one or more transfer devices 20, the transfer device controller 30, one or more base stations 40, one or more wireless terminals 50, and the wireless controller 60. The signal transfer system 100a is different from the signal transfer system 100 in that the wireless controller 60 is newly provided. Hereinafter, differences from the signal transfer system 100 will be mainly described.

The information transfer unit 31 of the transfer device controller 30 transfers the acquired network transfer information to the wireless controller 60.

The wireless controller 60 controls operation of the base station 40. Further, the wireless controller 60 includes an information transfer unit 61. The information transfer unit 61 included in the wireless controller 60 acquires the network transfer information transferred from the information transfer unit 31. The information transfer unit 61 transfers the acquired network transfer information to each base station 40.

As described above, each base station 40 may acquire the network transfer information not directly from the information transfer unit 31 included in the transfer device controller 30 but via the information transfer unit 61 included in the wireless controller 60. As processing after each base station 40 acquires the network transfer information, processing in steps S104 to S106 in the first embodiment is executed.

### Second Embodiment

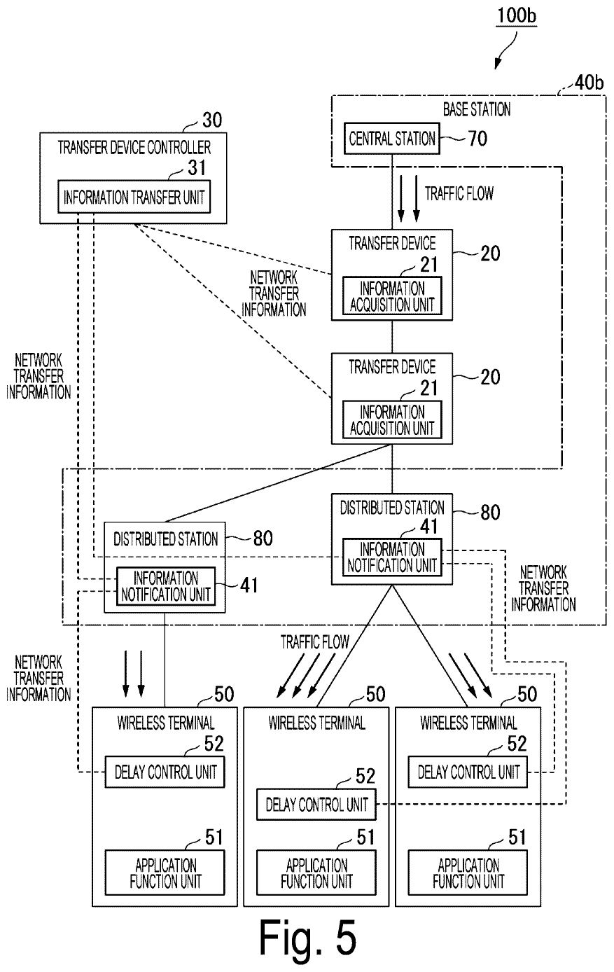

FIG. 5 is a diagram illustrating a system configuration example of a signal transfer system 100b according to a second embodiment. The signal transfer system 100b includes, for example, one or more transfer devices 20, the transfer device controller 30, a base station 40b, and one or more wireless terminals 50. The base station 40b includes a central station 70 and one or more distributed stations 80. As described above, the signal transfer system 100b is different from the signal transfer system 100 in that it does not include the server 10 but includes the base station 40b including the central station 70 and one or more distributed stations 80 instead of the base station 40. Hereinafter, differences from the signal transfer system 100 will be mainly described.

The central station 70 and one or more distributed stations 80 are configured using, for example, a processor such as a CPU, a memory, and a communication interface. Each device of the central station 70 and the one or more distributed stations 80 functions as a communication device including a control unit when the processor executes a program.

The control unit provides each function for causing the communication device to function as the central station 70 or the distributed station 80. Note that all or some of the functions of the control unit may be implemented by using hardware such as an ASIC, a PLD, or an FPGA. The program may be recorded on a computer-readable recording medium. The computer-readable recording medium is, for example, a portable medium such as a flexible disk, a magneto-optical disk, a ROM, a CD-ROM, or a semiconductor storage device (e.g., SSD), or a storage device such as a hard disk or a semiconductor storage device built in a computer system. The above-described program may be transmitted via a telecommunication line.

For example, the central station 70 and one or more distributed stations 80 in the second embodiment are a central unit (CU) and one or more distributed units (DU) in a mobile communication system. In this case, a section between the CU and the DUs where transfer devices 20 are installed is referred to as a mobile midhaul (MMH). For example, the central station 70 and the one or more distributed stations 80 in the second embodiment may be a DU and one or more radio units (RUs) in a mobile communication system. In this case, a section between the DU and the RUs where transfer devices 20 are installed is referred to as a mobile front haul (MFH).

Note that the central station 70 may be a Wi-Fi controller, and one or more distributed stations 80 may be Wi-Fi access points. The signal transfer system 100b is not necessarily applied to a mobile communication system, and may be applied to a wireless communication system other than the mobile communication system.

The central station 70 is a central station that transmits and receives signals. The central station 70 is an aspect of a higher-level device.

The distributed station 80 is a device that communicates with the wireless terminal 50. The distributed station 80 transmits a signal transferred from the transfer device 20 to the wireless terminal 50 or transfers a signal received from the wireless terminal 50 to the transfer device 20 as a transfer destination by communication with the wireless terminal 50.

The distributed station 80 includes the information notification unit 41. The information notification unit 41 included in the distributed station 80 acquires the network transfer information transferred from the information transfer unit 31. The information notification unit 41 included in the distributed station 80 notifies the wireless terminal 50 of the acquired network transfer information. Note that the information notification unit 41 may provide notification of the network transfer information together with the scheduling notification to the wireless terminal 50.

In the signal transfer system 100b in the second embodiment, the information notification unit 41 is included in the control unit of the distributed station 80.

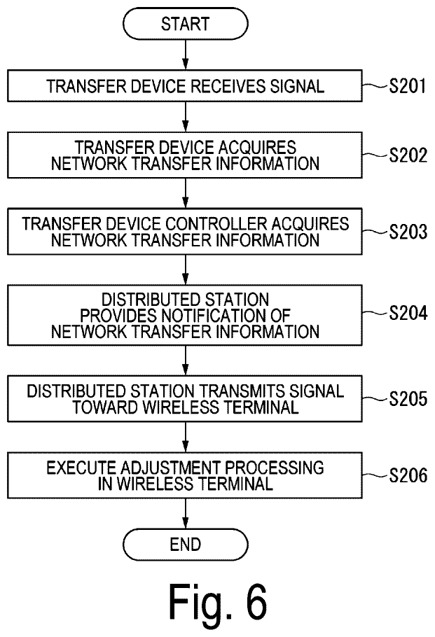

FIG. 6 is a flowchart illustrating an example of a flow of processing executed by the signal transfer system 100b according to the second embodiment. In the signal transfer system 100b, the processing illustrated in FIG. 6 is repeatedly performed.

The transfer device 20 receives a signal transmitted from the central station 70 (step S201). The information acquisition unit 21 included in the transfer device 20 acquires the network transfer information based on the received signal (step S202). The information acquisition unit 21 transmits the acquired network transfer information to the transfer device controller 30. Further, the information acquisition unit 21 transfers the received signal to the distributed station 80 to which the wireless terminal 50 as a destination is connected. The processing in step S202 is performed in all the transfer devices 20.

The information transfer unit 31 of the transfer device controller 30 acquires the network transfer information transmitted from each information acquisition unit 21 (step S203). The information transfer unit 31 transfers the acquired network transfer information to each distributed station 80. Note that the information transfer unit 31 transfers the acquired network transfer information to each distributed station 80 every time the network transfer information is acquired.

The information notification unit 41 included in the distributed station 80 acquires the network transfer information transferred from the information transfer unit 31. The information notification unit 41 notifies the wireless terminal 50 of the acquired network transfer information (step S204). Further, the distributed station 80 transmits the downlink signal transferred from the transfer device 20 to the wireless terminal 50 (step S205).

The delay control unit 52 of the wireless terminal 50 acquires the network transfer information and the downlink signal notification of which is provided from the distributed station 80. The delay control unit 52 grasps the frame size and the transmission interval of the frame based on the acquired network transfer information. The delay control unit 52 acquires a plurality of frames corresponding to the grasped frame size as downlink signals, and then executes adjustment processing on the plurality of frames (step S206). As a result, the frame intervals of the plurality of frames are uniformly adjusted, and the jitter is reduced. Thereafter, the delay control unit 52 inputs the plurality of frames subjected to the adjustment processing to the application function unit 51. The application function unit 51 processes a plurality of input frames.

According to the signal transfer system 100b configured as described above, before the plurality of frames are input to the application function unit 51, the wireless terminal 50 executes the adjustment processing of adjusting the frame interval of the plurality of frames based on the network transfer information acquired from the distributed station 80. This makes it possible to reduce jitter occurring in the downlink.

### Modification Example

The signal transfer system 100b may include a wireless controller 60, and the distributed station 80 may obtain the network transfer information from the wireless controller 60. In such a configuration, the information transfer unit 31 of the transfer device controller 30 transfers the acquired network transfer information to the wireless controller 60. The wireless controller 60 controls the operation of each distributed station 80. Further, the wireless controller 60 includes an information transfer unit 61. The information transfer unit 61 included in the wireless controller 60 acquires the network transfer information transferred from the information transfer unit 31. The information transfer unit 61 transfers the acquired network transfer information to each distributed station 80.

As described above, each distributed station 80 may acquire the network transfer information not directly from the information transfer unit 31 included in the transfer device controller 30 but via the information transfer unit 61 included in the wireless controller 60. As processing after each distributed station 80 acquires the network transfer information, processing in steps S204 to S206 in the second embodiment is executed.

### Third Embodiment

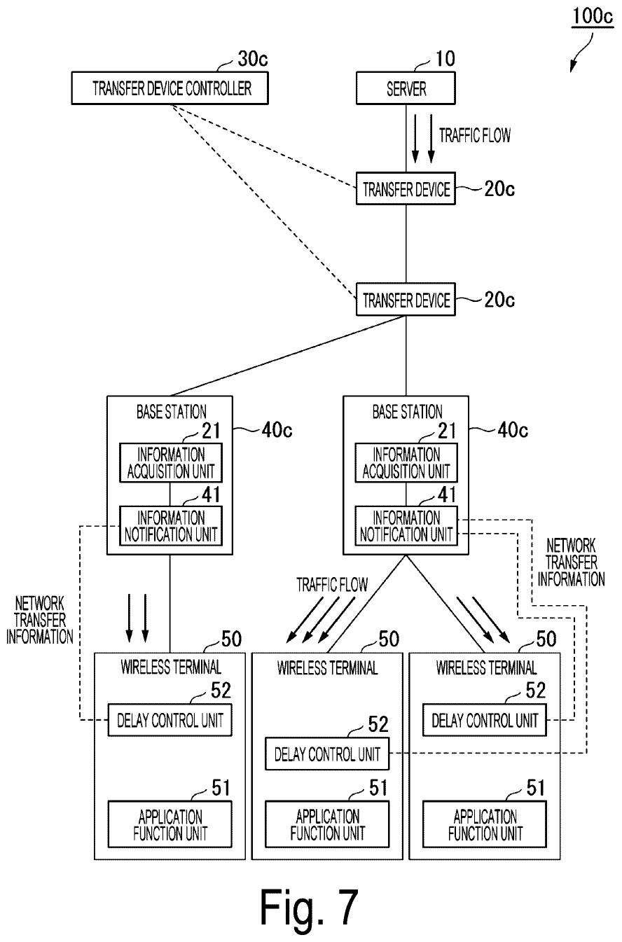

FIG. 7 is a diagram illustrating a system configuration example of a signal transfer system 100c according to the third embodiment. The signal transfer system 100c includes, for example, the server 10, one or more transfer devices 20c, a transfer device controller 30c, a base station 40c, and one or more wireless terminals 50. The signal transfer system 100c is different from the signal transfer system 100 in including a transfer device 20c, a transfer device controller 30c, and a base station 40c instead of the transfer device 20, the transfer device controller 30, and the base station 40. Hereinafter, differences from the signal transfer system 100 will be mainly described.

The transfer device 20c, the transfer device controller 30c, and the base station 40c are configured using, for example, a processor such as a CPU, a memory, and a communication interface. Each device of the transfer device 20c, the transfer device controller 30c, and the base station 40c functions as a communication device including a control unit when the processor executes a program.

The control unit provides each function for causing the communication device to function as the transfer device 20c, the transfer device controller 30c, or the base station 40c. Note that all or some of the functions of the control unit may be implemented by using hardware such as an ASIC, a PLD, or an FPGA. The program may be recorded on a computer-readable recording medium. The computer-readable recording medium is, for example, a portable medium such as a flexible disk, a magneto-optical disk, a ROM, a CD-ROM, or a semiconductor storage device (e.g., SSD), or a storage device such as a hard disk or a semiconductor storage device built in a computer system. The above-described program may be transmitted via a telecommunication line.

The transfer device 20c is different from the transfer device 20 in not including the information acquisition unit 21. Therefore, the transfer device 20c does not acquire the network transfer information. The transfer device 20c is a device that transfers a signal exchanged between the server 10 and each of one or more wireless terminals 50. For example, the transfer device 20c transfers the downlink signal transmitted from the server 10 to the base station 40c to which the wireless terminal 50 as a destination is connected.

The transfer device controller 30c is different from the transfer device controller 30 in that the information transfer unit 31 is not provided. Therefore, the transfer device controller 30c does not acquire the network transfer information. The transfer device controller 30c is a device that controls one or more transfer devices 20c by transmitting a control signal.

The base station 40c is a device that communicates with each of one or more wireless terminals 50. For example, the base station 40c transmits a signal transferred from the transfer device 20c to the wireless terminal 50, and transfers a signal received from the wireless terminal 50 to the transfer device 20c. Further, the base station 40c acquires the network transfer information based on the downlink signal transferred from the transfer device 20c, and notifies the wireless terminal 50 connected to the base station 40c itself of the acquired network transfer information.

The base station 40c includes the information acquisition unit 21 and the information notification unit 41. That is, the base station 40c is different from the base station 40 in further including the information acquisition unit 21. The information acquisition unit 21 included in the base station 40c acquires the network transfer information based on the downlink signal received by the base station 40c. The information notification unit 41 included in the base station 40c acquires the network transfer information acquired by the information acquisition unit 21. The information notification unit 41 included in the base station 40c notifies the wireless terminal 50 of the acquired network transfer information. Note that the information notification unit 41 may provide notification of the network transfer information together with the scheduling notification to the wireless terminal 50.

Note that each of the base stations 40c may be, for example, a Wi-Fi (registered trademark) access point. The signal transfer system 100c is not necessarily applied to a mobile communication system, and may be applied to a wireless communication system other than the mobile communication system.

In the signal transfer system 100c according to the third embodiment, the information acquisition unit 21 and the information notification unit 41 are included in a control unit of the base station 40c.

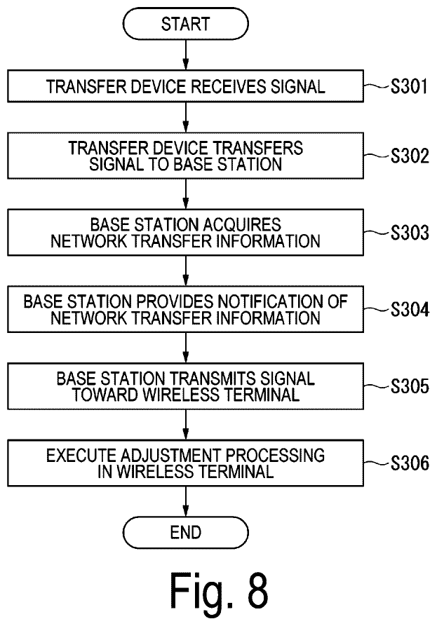

FIG. 8 is a flowchart illustrating an example of a flow of processing executed by the signal transfer system 100c according to the third embodiment. In the signal transfer system 100c, the processing illustrated in FIG. 8 is repeatedly performed.

The transfer device 20c receives a signal transmitted from the server 10 (step S301). The transfer device 20c transfers the received signal to the base station 40c to which the wireless terminal 50 serving as a destination is connected (step S302). The processing in step S302 is performed in all the transfer devices 20c.

The information acquisition unit 21 of the base station 40c acquires the network transfer information based on the signal transferred from the transfer device 20c (step S303). The information acquisition unit 21 outputs the acquired network transfer information to the information notification unit 41. The information notification unit 41 acquires the network transfer information output from the information acquisition unit 21. The information notification unit 41 notifies the wireless terminal 50 of the acquired network transfer information (step S304). Further, the base station 40c transmits the downlink signal transferred from the transfer device 20c to the wireless terminal 50 (step S305).

The delay control unit 52 of the wireless terminal 50 acquires the network transfer information and the downlink signal notification of which is provided from the base station 40c. The delay control unit 52 grasps the frame size and the transmission interval of the frame based on the acquired network transfer information. The delay control unit 52 acquires a plurality of frames corresponding to the grasped frame size as downlink signals, and then executes adjustment processing on the plurality of frames (step S306). As a result, the frame intervals of the plurality of frames are uniformly adjusted, and the jitter is reduced. Thereafter, the delay control unit 52 inputs the plurality of frames subjected to the adjustment processing to the application function unit 51. The application function unit 51 processes a plurality of input frames.

According to the signal transfer system 100c configured as described above, before the plurality of frames are input to the application function unit 51, the wireless terminal 50 executes the adjustment processing of adjusting the frame interval of the plurality of frames based on the network transfer information acquired from the base station 40c. This makes it possible to reduce jitter occurring in the downlink.

Furthermore, in the signal transfer system 100c, the base station 40c performs from acquisition of the network transfer information to notification to the wireless terminal 50. As a result, the transfer device 20c may not have the function of acquiring the network transfer information. Therefore, a transfer device including a normal transfer function can be used as the transfer device 20c.

### Fourth Embodiment

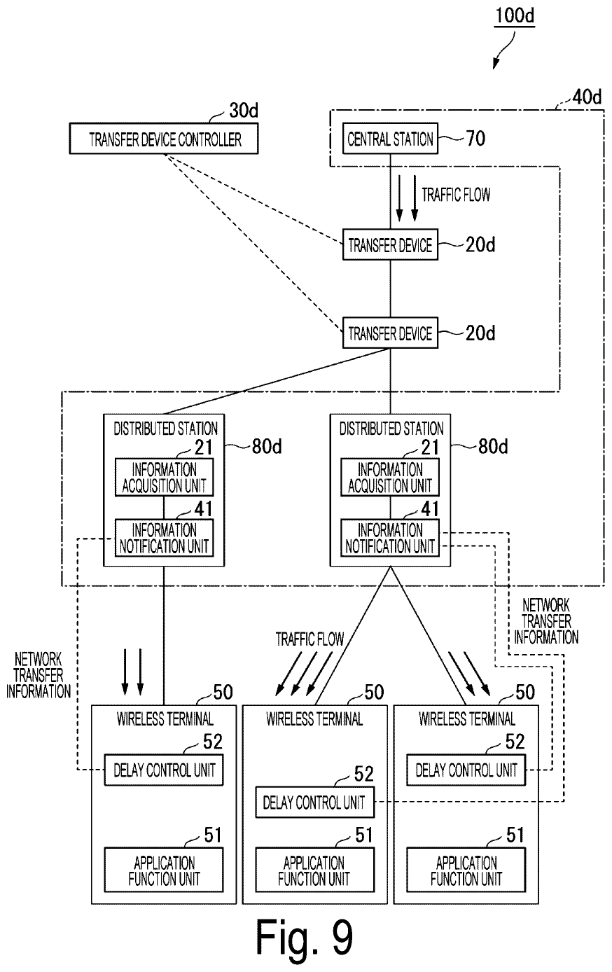

FIG. 9 is a diagram illustrating a system configuration example of a signal transfer system 100d according to a fourth embodiment. The signal transfer system 100d includes, for example, one or more transfer devices 20d, a transfer device controller 30d, a base station 40d, and one or more wireless terminals 50. The base station 40d includes the central station 70 and one or more distributed stations 80d. As described above, the signal transfer system 100d is different from the signal transfer system 100b in including the transfer device 20d, the transfer device controller 30d, and the base station 40d instead of the transfer device 20, the transfer device controller 30, and the base station 40b. Hereinafter, differences from the signal transfer system 100b will be mainly described.

The transfer device 20d, the transfer device controller 30d, and the base station 40d are configured using, for example, a processor such as a CPU, a memory, and a communication interface. Each device of the transfer device 20d, the transfer device controller 30d, and the base station 40d functions as a communication device including a control unit when the processor executes a program.

The control unit provides each function for causing the communication device to function as the transfer device 20d, the transfer device controller 30d, or the base station 40d. Note that all or some of the functions of the control unit may be implemented by using hardware such as an ASIC, a PLD, or an FPGA. The program may be recorded on a computer-readable recording medium. The computer-readable recording medium is, for example, a portable medium such as a flexible disk, a magneto-optical disk, a ROM, a CD-ROM, or a semiconductor storage device (e.g., SSD), or a storage device such as a hard disk or a semiconductor storage device built in a computer system. The above-described program may be transmitted via a telecommunication line.

The transfer device 20d is different from the transfer device 20 in not including the information acquisition unit 21. Therefore, the transfer device 20d does not acquire the network transfer information. The transfer device 20d is a device that transfers a signal exchanged between the central station 70 and each of one or more wireless terminals 50. For example, the transfer device 20d transfers the downlink signal transmitted from the central station 70 to the distributed station 80d to which the wireless terminal 50 as a destination is connected.

The transfer device controller 30d is different from the transfer device controller 30 in that the information transfer unit 31 is not provided. Therefore, the transfer device controller 30d does not acquire the network transfer information. The transfer device controller 30d is a device that controls one or more transfer devices 20d by transmitting a control signal.

The distributed station 80d is a device that communicates with the wireless terminal 50. The distributed station 80d transmits a signal transferred from the transfer device 20d to the wireless terminal 50 or transfers a signal received from the wireless terminal 50 to the transfer device 20d as a transfer destination by communication with the wireless terminal 50. Further, the distributed station 80d acquires the network transfer information based on the downlink signal transferred from the transfer device 20d, and notifies the wireless terminal 50 connected to its own device of the acquired network transfer information.

The distributed station 80d includes the information acquisition unit 21 and the information notification unit 41. That is, the distributed station 80d is different from the distributed station 80 in further including the information acquisition unit 21. The information acquisition unit 21 included in the distributed station 80d acquires the network transfer information based on the downlink signal received by the distributed station 80d. The information notification unit 41 included in the distributed station 80d acquires the network transfer information acquired by the information acquisition unit 21. The information notification unit 41 included in the distributed station 80d notifies the wireless terminal 50 of the acquired network transfer information. Note that the information notification unit 41 may provide notification of the network transfer information together with the scheduling notification to the wireless terminal 50.

In the signal transfer system 100d according to the fourth embodiment, the information acquisition unit 21 and the information notification unit 41 are included in a control unit of the distributed station 80d.

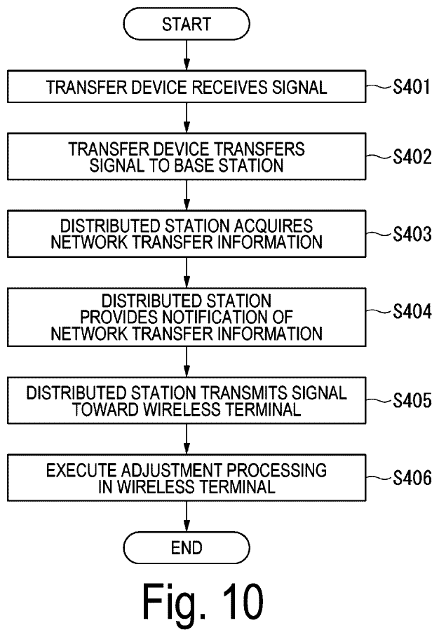

FIG. 10 is a flowchart illustrating an example of a flow of processing executed by the signal transfer system 100d according to the fourth embodiment. In the signal transfer system 100d, the processing illustrated in FIG. 10 is repeatedly performed.

The transfer device 20d receives a signal transmitted from the central station 70 (step S401). The transfer device 20d transfers the received signal to the distributed station 80d to which the wireless terminal 50 as a destination is connected (step S402). The processing in step S402 is performed in all the transfer devices 20d.

The information acquisition unit 21 of the distributed station 80d acquires the network transfer information based on the signal transferred from the transfer device 20d (step S403). The information acquisition unit 21 outputs the acquired network transfer information to the information notification unit 41. The information notification unit 41 acquires the network transfer information output from the information acquisition unit 21. The information notification unit 41 notifies the wireless terminal 50 of the acquired network transfer information (step S404). Further, the distributed station 80d transmits the downlink signal transferred from the transfer device 20d to the wireless terminal 50 (step S405).

The delay control unit 52 of the wireless terminal 50 acquires the network transfer information and the downlink signal notification of which is provided from the distributed station 80d. The delay control unit 52 grasps the frame size and the transmission interval of the frame based on the acquired network transfer information. The delay control unit 52 acquires a plurality of frames corresponding to the grasped frame size as downlink signals, and then executes adjustment processing on the plurality of frames (step S406). As a result, the frame intervals of the plurality of frames are uniformly adjusted, and the jitter is reduced. Thereafter, the delay control unit 52 inputs the plurality of frames subjected to the adjustment processing to the application function unit 51. The application function unit 51 processes a plurality of input frames.

According to the signal transfer system 100d configured as described above, before the plurality of frames are input to the application function unit 51, the wireless terminal 50 executes the adjustment processing of adjusting the frame interval of the plurality of frames based on the network transfer information acquired from the distributed station 80d. This makes it possible to reduce jitter occurring in the downlink.

Furthermore, in the signal transfer system 100d, the distributed station 80d performs from acquisition of the network transfer information to notification to the wireless terminal 50. As a result, the transfer device 20d may not have the function of acquiring the network transfer information. Therefore, a transfer device including a normal transfer function can be used as the transfer device 20d.

Although the embodiments of the present invention have been described in detail with reference to the drawings, specific configurations are not limited to the embodiments and include design and the like within the scope of the present invention without departing from the gist of the present invention.

### INDUSTRIAL APPLICABILITY

The present invention is applicable to a communication system that accommodates a wireless terminal, and a communication control method.

### REFERENCE SIGNS LIST

10 Server

20, 20c, 20d Transfer device

21 Information acquisition unit

30, 30c, 30d Transfer device controller

31 Information transfer unit

40, 40b, 40c, 40d Base station

41 Information notification unit

50 Wireless terminal

51 Application function unit

52 Delay control unit

60 Wireless controller

61 Information transfer unit

70 Central station

80, 80d Distributed station

100, 100a, 100b, 100c, 100d Signal transfer system

1. A wireless terminal comprising:
an application processor configured to process a signal transmitted from a host device to a wireless terminal; and
a delay controller configured to acquire network transfer information, which is information regarding a traffic flow, from the outside for each traffic flow from the host device toward the wireless terminal, and executes adjustment processing of adjusting a frame interval of a plurality of frames based on the acquired network transfer information before the plurality of frames are input to the application processor.

2. The wireless terminal according to claim 1, wherein
the delay controller executes the adjustment processing so that frame intervals of the plurality of frames are uniform.

3. The wireless terminal according to claim 1, wherein
the delay controller shapes the plurality of frames as the adjustment processing.

4. The wireless terminal according to claim 1, wherein
the delay controller adds a delay to each of the plurality of frames as the adjustment processing.

5. The wireless terminal according to claim 1, wherein
the information related to the traffic flow indicates a downlink frame size and a transmission interval.

6. A signal transfer system comprising:
the wireless terminal according to claim 1;
one or more base stations configured to accommodate the wireless terminal;
one or more transfer devices configured to transfer downstream communication addressed to the wireless terminal;
a transfer device controller configured to control the one or more transfer devices;
an information acquirer configured to acquire network transfer information which is information related to a traffic flow for each traffic flow from a host device toward the wireless terminal;
an information notifier configured to notify the wireless terminal of the network transfer information acquired by the information acquirer; and
a delay controller configured to execute, in the wireless terminal, adjustment processing of adjusting a frame interval of a plurality of frames based on the network transfer information notification of which is provided from the information notifier before the plurality of frames are input to an application processor unit that processes the plurality of frames transmitted from the host device to the wireless terminal.

7. A signal processing method comprising:
acquiring network transfer information that is information related to a traffic flow from the outside for each traffic flow from a host device toward a wireless terminal; and
executing adjustment processing of adjusting a frame interval of a plurality of frames based on the acquired network transfer information before the plurality of frames are input to an application processor that processes a signal transmitted from the host device to the wireless terminal.
